(19) United States
(12) Patent Application Publication
(10) Pub. No.: US 2005/0260061 A1
(43) Pub. Date: Nov. 24, 2005

(54) Screw washer

(76) Inventor: Li-Fu Sung, Sanchong City (TW)

Correspondence Address: RABIN & Berdo, PC, 1101 14TH STREET, NW, SUITE 500, WASHINGTON, DC, 20005, US

(21) Appl. No.: 11/133,316

(22) Filed: May 20, 2005

(30) Foreign Application Priority Data
May 24, 2004 (TW) 93114665

(51) Int. Cl. F16B 13/04

(52) U.S. Cl. 411/533

(57) ABSTRACT

A screw washer for combining with a screw to screw a first piece onto a second piece includes a spacer part and a hooking part. The spacer part has a spacer opening and the hooking part is connected to the spacer part. When the screw pierces through the spacer opening to screw the first piece onto the second piece, the spacer part is clipped between a screw head of the screw and the first piece, and the hooking part is used to clasp the screw.

This application claims the benefit of Taiwan application Serial No. 93114665, filed May 24, 2004, the subject matter of which is incorporated herein by reference.

### BACKGROUND OF THE INVENTION

1. Field of the Invention

The invention relates in general to a screw washer, and more particularly to a screw washer free from falling down and free from being lost when the screw is loosened.

2. Description of the Related Art

In the design for electrical products, the electrical connection between metal pieces has to be avoided in order to avoid the electromagnetic interference. More particularly, when a metal screw is used to screw two metal pieces, the electrical connection between the pair of screwed pieces often exists. Thus, the electrical connection has to be avoided. For example, when a screw is used to screw an iron piece of a liquid crystal display onto an iron piece of a foot structure, the electromagnetic wave generated by the liquid crystal display tends to radiate out through the foot to encompass the electromagnetic interference.

FIG. 1 is a cross-sectional view showing a screw washer to be combined with a screw for screwing two metal pieces according to the prior art. As shown in FIG. 1, a screw 100 is combined with a screw washer 110 to screw metal pieces 120 and 130. The screw washer 110 includes a spacer part 112 and a screw-body padding part 114. The spacer part 112 isolates a screw head 102 from the metal piece 120, and the screw-body padding part 114 isolates a screw body 104 from the metal piece 120. Thus, the screw washer 110 can prevent the screw 100 from electrically coupling the metal piece 120 to the metal piece 130.

According to the design of the screw washer 110, however, when the metal piece 120 and the metal piece 130 are disassembled, the screw washer 110 tends to fall down or to be lost after the screw 100 is loosened, thereby encompassing the inconvenience in maintenance. In particular, when the user is replacing the pieces, if the screw washer is loosened, it cannot be ensured that the user can install the loosened screw washer back correctly, and the loss of the screw washer causes inconvenience because a new screw washer has to be purchased.

### SUMMARY OF THE INVENTION

It is therefore an object of the invention to provide a novel screw washer having a hooking part to clasp a screw. When the screw is being loosened, the screw washer can be loosened together to prevent the screw washer from falling down or from being lost.

The invention achieves the above-identified object by providing a screw washer for combining with a screw to screw a first piece onto a second piece. The screw washer includes a spacer part and a hooking part. The spacer part has a spacer opening and the hooking part is connected to the spacer part. When the screw pierces through the spacer opening to screw the first piece onto the second piece, the spacer part is clipped between a screw head of the screw and the first piece, and the hooking part is used to clasp the screw. When the screw for screwing the first piece onto the second piece is unscrewed, the screw washer clasps the screw with the hooking part and is loosened together with the screw.

The hooking part includes a projection part and a body portion. The body portion is connected to an edge of the spacer opening. When the screw pierces through the spacer opening to screw the first piece onto the second piece, the projection part clasps a thread of the screw. When the screw pierces through the spacer opening to screw the first piece onto the second piece, the body portion contacts partial side surface of a screw body of the screw. Each of the first piece and the second piece is a metal piece. The spacer part and the hooking part are used to prevent the screw from electrically coupling the first piece to the second piece.

The hooking part includes a projection part and a body portion. The body portion is connected to an outer edge of the spacer part. When the screw pierces through the spacer opening to screw the first piece onto the second piece, the projection part clasps an upper edge of a side surface of the screw head. When the screw pierces through the spacer opening to screw the first piece onto the second piece, the body portion contacts a portion of a side surface of the screw head.

The screw washer further includes a screw-body padding part connected to an edge of the spacer opening. When the screw pierces through the spacer opening to screw the first piece onto the second piece, the screw-body padding part is clipped between the screw body of the screw and the first piece. Each of the first piece and the second piece is a metal piece, and the screw-body padding part and the spacer part are used to prevent the screw from electrically connecting the first piece to the second piece. Thus, the hooking part of the invention can prevent the screw washer from falling down or from being lost.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a cross-sectional view showing a screw washer to be combined with a screw for screwing two metal pieces according to the prior art.

FIG. 2A is a cross-sectional view showing a screw washer to be combined with a screw for screwing two pieces according to a first embodiment of the invention.

FIG. 2B is a body view showing the screw washer of FIG. 2A.

FIG. 2C is a cross-sectional view showing a screw washer to be combined with a screw for screwing two pieces according to a second embodiment of the invention.

FIG. 2D is a body view showing the screw washer to be combined with the screw for screwing two pieces according to the second embodiment of the invention.

### DETAILED DESCRIPTION OF THE INVENTION

That the screw washers can be prevented from falling down and from being lost after the screw is loosened will be described with reference to two embodiments.

### Embodiment One

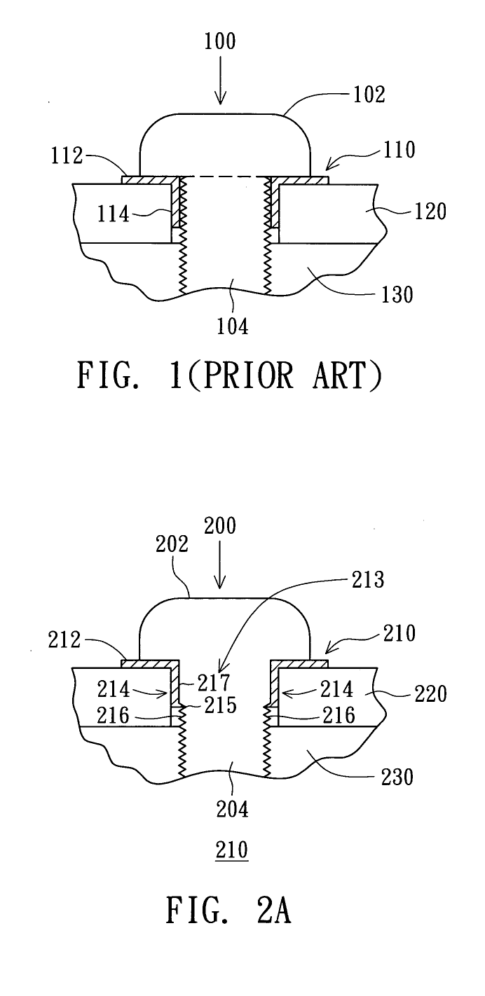

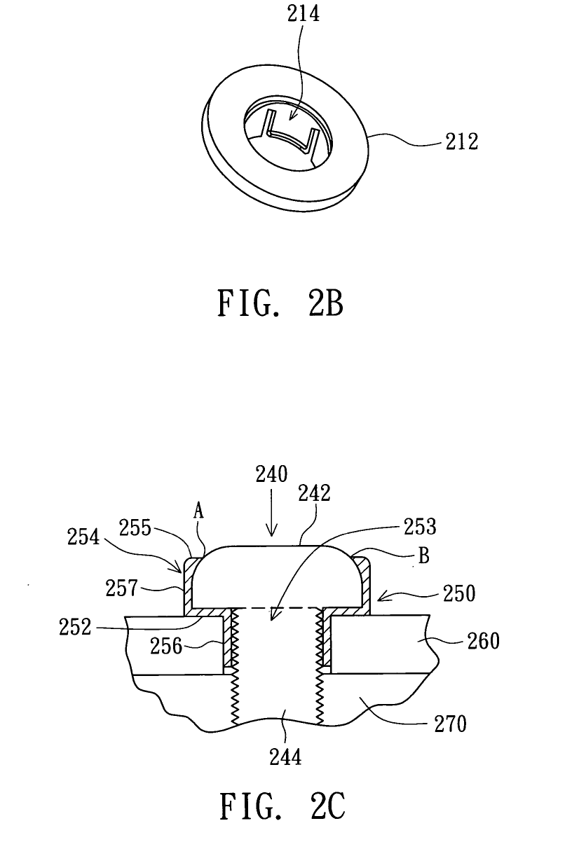

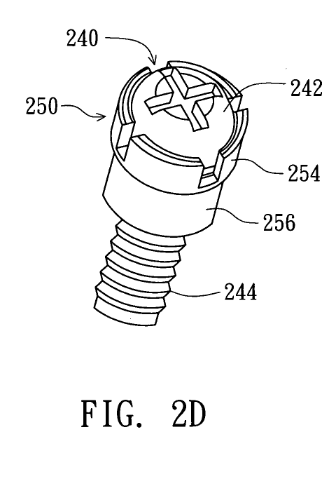

FIG. 2A is a cross-sectional view showing a screw washer to be combined with a screw for screwing two pieces according to a first embodiment of the invention. As shown in FIG. 2A, a screw washer 210 is combined with a screw 200 for screwing a first piece 220 onto a second piece 230. In this manner, the force of the screw 200, which is applied to the surface of the first piece 220, may be dispersed and the elastic deformation of the washer 210 prevents the screw 200 from loosening. The screw washer 210 includes a spacer part 212 and a hooking part 214. The spacer part 212 includes a spacer opening 213 and the hooking part 214 is connected to the spacer part 212. When the screw 200 pierces through the spacer opening 213 to screw the first piece 220 onto the second piece 230, the spacer part 212 is clipped between a screw head 202 of the screw 200 and the first pie\ce 220, and the hooking part 214 is used to clasp the screw 200.

As shown in FIG. 2A, the hooking part 214 includes a projection part 215 and a body portion 217. The body portion 217 is connected to an edge of the spacer opening 213. When the screw 200 pierces through the spacer opening 213 to screw the first piece 220 onto the second piece 230, the projection part 215 clasps a thread 216 of the screw 200. Meanwhile, the body portion 217 contacts partial side surface of a screw body 204 of the screw 200. As shown in FIG. 2B, the screw washer 210 may have several hooking parts 214. Thus, when the screw 200 for screwing the first piece 220 onto the second piece 230 is unscrewed, these hooking parts 214 of the screw washer 210 clasp the threads 216 of the screw 200 so that the screw washer 210 can be loosened together with the screw 200.

When each of the first piece 220 and the second piece 230 is a metal piece (e.g., the first piece 220 is a foot iron piece and the second piece 230 is a liquid crystal display), the screw washer 210 can prevent the screw 200 from electrically coupling the first piece 220 to the second piece 230 with the spacer part 212 and the hooking part 214. Thus, it is possible to prevent the electromagnetic wave, which is generated by the second piece 230, from transferring to the first piece 220 through the screw 200 and then radiating out from the first piece 220.

### Embodiment Two

FIG. 2C is a cross-sectional view showing a screw washer to be combined with a screw for screwing two pieces according to a second embodiment of the invention. As shown in FIG. 2C, a screw washer 250 is combined with a screw 240 for screwing a first piece 260 onto a second piece 270. In this manner, the force of the screw 240, which is applied to the surface of the first piece 260, may be dispersed and the elastic deformation of the washer 250 prevents the screw 240 from loosening. The screw washer 250 includes a spacer part 252, a hooking part 254 and a screw-body padding part 256. The spacer part 252 includes a spacer opening 253, and the hooking part 254 is connected to the spacer part 252. The screw-body padding part 256 is connected to an edge of the spacer opening 253. When the screw 240 pierces through the spacer opening 253 to screw the first piece 260 onto the second piece 270, the spacer part 252 is clipped between a screw head 242 of the screw 240 and the first piece 260, and the hooking part 254 is used to clasp the screw 240.

As shown in FIG. 2C, the hooking part 254 includes a projection part 255 and a body portion 257, which is connected to an outer edge of the spacer part 252. When the screw 240 pierces through the spacer opening 253 to screw the first piece 260 onto the second piece 270, the projection part 255 clasps an upper edge (e.g., points A and B) of a side surface of the screw head 242. The body portion 257 contacts a portion of a side surface of the screw head 242. Meanwhile, the screw-body padding part 256 is clipped between a screw body 244 of the screw 240 and the first piece 260. As shown in FIG. 2D, the screw washer 250 may have several hooking parts 254. Thus, when the screw 240 for screwing the first piece 260 onto the second piece 270 is unscrewed, these hooking parts 254 of the screw washer 250 clasp the upper edge of the side surface of the screw head 242 so that the screw washer 250 can be loosened together with the screw 240.

When each of the first piece 260 and the second piece 270 is a metal piece (e.g., the first piece 260 is a foot iron piece and the second piece 270 is a liquid crystal display), the screw washer 250 can prevent the screw 240 from electrically coupling the first piece 260 to the second piece 270 with the spacer part 252 and the screw-body padding part 256. Thus, it is possible to prevent the electromagnetic wave generated by the second piece 270 from transferring to the first piece 260 through the screw 240 and then radiating out from the first piece 260.

According to the two embodiments, the advantage of the screw washer of the invention is that the hooking part of the screw washer can clasp the screw to prevent the screw washer from falling down or from being lost in the prior art when the screw is unscrewed from the screwed pieces. Meanwhile, the spacer part and the hooking part or the screw-body padding part of the screw washer can effectively prevent the screw from electrically coupling the screwed metal piece pairs.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A screw washer, for combining with a screw to screw a first piece onto a second piece, the screw washer comprising:
a spacer part, having a spacer opening; and
a hooking part, connected to the spacer part,
wherein when the screw pierces through the spacer opening to screw the first piece onto the second piece, the spacer part is clipped between a screw head of the screw and the first piece, and the hooking part is used to clasp the screw.

2. The screw washer according to claim 1, wherein when the screw for screwing the first piece onto the second piece is unscrewed, the screw washer clasps the screw with the hooking part and is loosened together with the screw.

3. The screw washer according to claim 1, wherein the hooking part comprises a projection part and a body portion, the body portion is connected to an edge of the spacer opening, and when the screw pierces through the spacer opening to screw the first piece onto the second piece, the projection part clasps a thread of the screw.

4. The screw washer according to claim 3, wherein when the screw pierces through the spacer opening to screw the first piece onto the second piece, the body portion contacts partial side surface of a screw body of the screw.

5. The screw washer according to claim 4, wherein each of the first piece and the second piece is a metal piece, and the spacer part and the hooking part prevent the screw from electrically coupling the first piece to the second piece.

6. The screw washer according to claim 1, wherein the hooking part comprises a projection part and a body portion, the body portion is connected to an outer edge of the spacer part, and when the screw pierces through the spacer opening to screw the first piece onto the second piece, the projection part clasps an upper edge of a side surface of the screw head.

7. The screw washer according to claim 6, wherein when the screw pierces through the spacer opening to screw the first piece onto the second piece, the body portion contacts a portion of a side surface of the screw head.

8. The screw washer according to claim 6, wherein the screw washer further comprises a screw-body padding part connected to an edge of the spacer opening, and when the screw pierces through the spacer opening to screw the first piece onto the second piece, the screw-body padding part is clipped between a screw body of the screw and the first piece.

9. The screw washer according to claim 8, wherein each of the first piece and the second piece is a metal piece, and the screw-body padding part and the spacer part are for preventing the screw from electrically coupling the first piece to the second piece.

10. The screw washer according to claim 1, wherein the second piece is a liquid crystal display.
